(19) United States
(12) Patent Application Publication
(10) Pub. No.: US 2026/0104853 A1
(43) Pub. Date: Apr. 16, 2026

(54) SYSTEM

(71) Applicant: TOYOTA JIDOSHA KABUSHIKI KAISHA, Toyota-shi (JP)

(72) Inventor: Masayuki OKAMOTO, Nagoya-shi (JP)

(73) Assignee: TOYOTA JIDOSHA KABUSHIKI KAISHA, Toyota-shi (JP)

(21) Appl. No.: 19/227,945

(22) Filed: Jun. 4, 2025

(30) Foreign Application Priority Data
Oct. 15, 2024 (JP) 2024-180245

(51) Int. Cl. G06F 3/16

(52) U.S. Cl. CPC G06F 3/167

(57) ABSTRACT

The system includes: a first generator capable of generating answer contents to a request of a user of the vehicle; a second generator capable of generating a voice including answer contents to the request; and a display that displays visual information indicating that at least one of the first generator and the second generator is involved in the voice answer when at least one of the first generator and the second generator performs at least one of generation of the answer contents to the request and generation of the voice including the answer contents to the request.

### CROSS-REFERENCE TO RELATED APPLICATION

This application claims priority to Japanese Patent Application No. 2024-180245 filed on Oct. 15, 2024. The disclosure of the above-identified application, including the specification, drawings, and claims, is incorporated by reference herein in its entirety.

### BACKGROUND

### 1. Technical Field

The present disclosure relates to a system, and more particularly, to a technical field of a system for giving a notification about whether artificial intelligence (AI) is involved.

### 2. Description of Related Art

For example, AI chatbots using avatars have been proposed. As a technology for displaying an avatar, for example, there has been proposed a technology in which a video including a computer graphics (CG) character of a speaker is displayed on a display screen in accordance with the structure of conversation program data based on structural data, content analysis data, and identification data extracted from conversation data (see Japanese Unexamined Patent Application Publication No. 2003-323628 (JP 2003-323628 A)).

### SUMMARY

For example, it may be difficult for a user to determine whether AI is involved in an answer in a service in which a user's voice-based question is answered by voice via communication means.

The present disclosure provides a system in which a user can determine whether AI is involved in an answer.

A system according to one aspect of the present disclosure includes:
a first generator for generating an answer content to a request of a user of a vehicle;
a second generator for generating a voice including the answer content to the request; and
a display for displaying visual information indicating that at least one of the first generator and the second generator is involved in an answer using the voice when at least one of the first generator and the second generator performs at least one of generation of the answer content to the request and generation of the voice including the answer content to the request.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a configuration of a system according to an embodiment;

FIG. 2 is a flowchart illustrating an example of an operation of the system according to the embodiment;

FIG. 3 is a diagram illustrating an example of an image related to setting of an answer;

FIG. 4 is a diagram illustrating exemplary images displayed at the time of reply; and

FIG. 5 is a block diagram illustrating another example of the configuration of the system according to the embodiment.

### DETAILED DESCRIPTION OF EMBODIMENTS

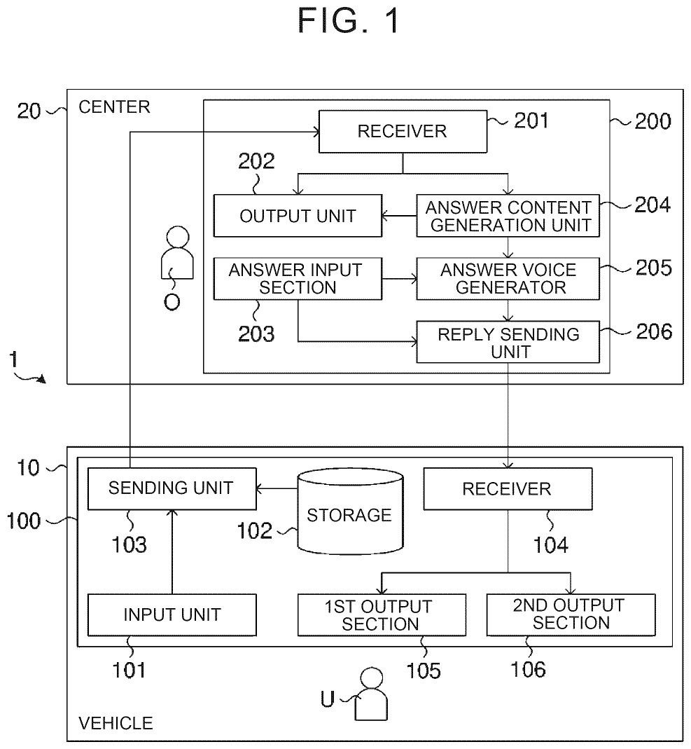

An embodiment of the system will be described with reference to FIGS. 1 to 4.

### System Configuration

A configuration of the system 1 according to the embodiment will be described with reference to FIG. 1. In FIG. 1, a system 1 includes a notification means identification device 100 mounted on a vehicle 10 and a notification content generation device 200 installed in a center 20. The notification means identification device 100 and the notification content generation device 200 are configured to be able to communicate with each other via a network. For example, the vehicle 10 may be a so-called connected car. The center 20 is a center for supporting the user U of the vehicle 10. For example, the center 20 may be referred to as a contact center.

For example, the user U of the vehicle 10 may make a request to the center 20 to “search for a nearby parking lot” via the notification means identification device 100. The notification content generation device 200 of the center 20 may transmit an answer to the request to the notification means identification device 100. The notification means identification device 100 may notify the user U of the received answer. The services provided by the notification means identification device 100 and the notification content generation device 200 are hereinafter referred to as “agent services” as appropriate.

In the system 1, the answer to the request of the user U is made by at least one of the operator O (i.e., a human) and AI of the center 20. The user U may respond to the request only by the operator O or only by AI. The answer to the request of the user U may be made by the operator O creating the answer content and outputting the answer content in the synthesized speech by AI. The answer to the request of the user U may be made by AI generating the answer content and the operator O reading the answer content.

The notification means identification device 100 includes an input unit 101, a storage unit 102, a transmission unit 103, a reception unit 104, a first output unit 105, and a second output unit 106.

The input unit 101 has a voice input function. That is, the input unit 101 can recognize a voice uttered by the user U. The input unit 101 may include a microphone to implement a voice input function. The first output unit 105 outputs visual information. For example, the first output unit 105 may be a display. The second output unit 106 outputs audio information. For example, the second output unit 106 may be a speaker. Note that at least one of the input unit 101, the first output unit 105, and the second output unit 106 may be realized by HMI (Human Machine Interface) of the vehicles 10. That is, a part of the notification means identification device 100 may be realized by HMI of the vehicles 10.

The storage unit 102 is a storage unit. For example, the storage unit 102 may be realized by at least one of a nonvolatile memory and a hard disk drive. For example, the storage unit 102 may store answer setting information indicating a desire of the user U to answer the answer from the center 20. The answer setting information may include at least one of a desire for an answer by the operator O, a desire for an answer by AI, and a desire for an answer by the operator O and AI. The transmission unit 103 transmits the request information related to the request of the user U input via the input unit 101 to the notification content generation device 200. The reception unit 104 receives answer information related to the answer transmitted from the notification content generation device 200.

The notification content generation device 200 includes a reception unit 201, an output unit 202, an answer input unit 203, an answer content generation unit 204, an answer voice generation unit 205, and an answer transmission unit 206. The output unit 202 and the answer input unit 203 are portions used when the operator O is involved in the answer. The answer content generation unit 204 and the answer voice generation unit 205 are used when AI is involved in the answer.

The reception unit 201 receives the request information transmitted from the notification means identification device 100. The output unit 202 may output the request information received by the reception unit 201. For example, the output unit 202 may include a speaker and a display. The answer input unit 203 has a voice input function. The answer input unit 203 may include a microphone to implement a voice input function. The operator O may perform a voice response to the request related to the request information via the answer input unit 203. The answer transmission unit 206 may transmit the answer information related to the voice answer by the operator O to the notification means identification device 100.

The request information received by the reception unit 201 may be input to the answer content generation unit 204. The answer content generation unit 204 may generate the answer content for the request related to the request information by using AI. AI used by the answer content generation unit 204 may include a learned model that generates an answer content to the request when the request related to the request information is inputted. The answer content generated by the answer content generation unit 204 may be output in a text data format. The answer content generated by the answer content generation unit 204 may be input to the answer voice generation unit 205. The answer voice generation unit 205 may generate voice data corresponding to the answer content generated by the answer content generation unit 204 using AI. AI used by the answer voice generation unit 205 may include a learned model that generates voice information corresponding to the answer content when the answer content generated by the answer content generation unit 204 is inputted. The answer transmission unit 206 may transmit the voice information generated by the answer voice generation unit 205 to the notification means identification device 100 as the answer information.

The information related to the answer content generated by the answer content generation unit 204 may be transmitted to the output unit 202. For example, the output unit 202 may display the answer content generated by the answer content generation unit 204. In this case, the operator O may read out the answer content generated by the answer content generation unit 204. The answer information may be generated by the operator O reading out the answer content generated by the answer content generation unit 204 via the answer input unit 203. The answer transmission unit 206 may transmit the answer information to the notification means identification device 100.

The operator O may create answer contents to the request related to the request information output by the output unit 202. For example, the operator O may voice-input the answer content to the request via the answer input unit 203. The answer voice generation unit 205, which may be input to the answer voice generation unit 205, may generate voice information corresponding to the information related to the voice input answer content using AI. The answer transmission unit 206 may transmit the voice information generated by the answer voice generation unit 205 to the notification means identification device 100 as the answer information.

### System Operation

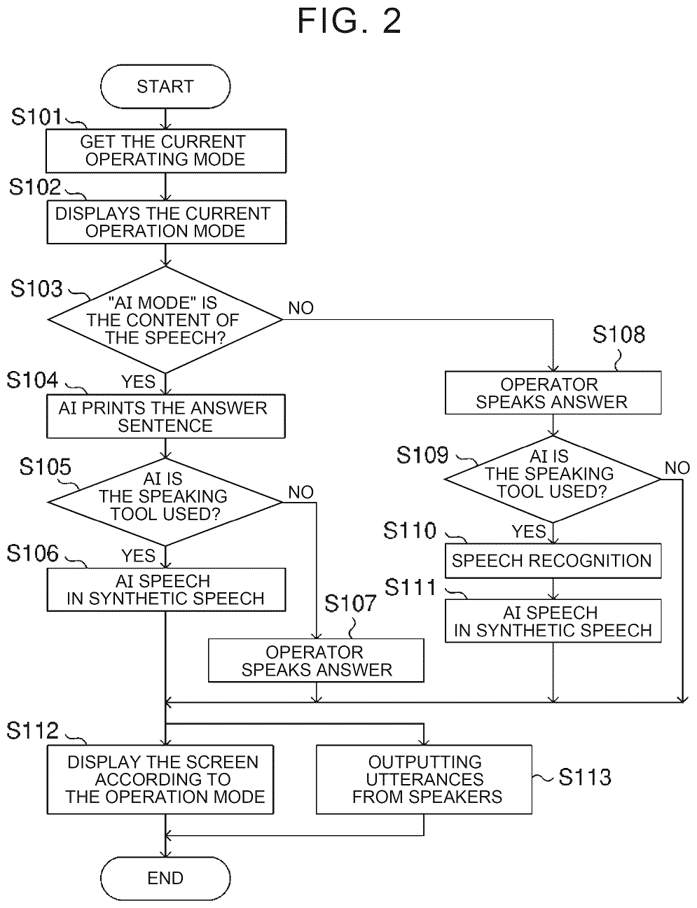

Next, the operation of the system 1 will be described with reference to the flowchart of FIG. 2. In FIG. 2, the first output unit 105 of the notification means identification device 100 acquires the present operation mode of the agent service based on the answer setting information stored in the storage unit 102 (S101). Next, the first output unit 105 displays images indicating the obtained operation modes (S102).

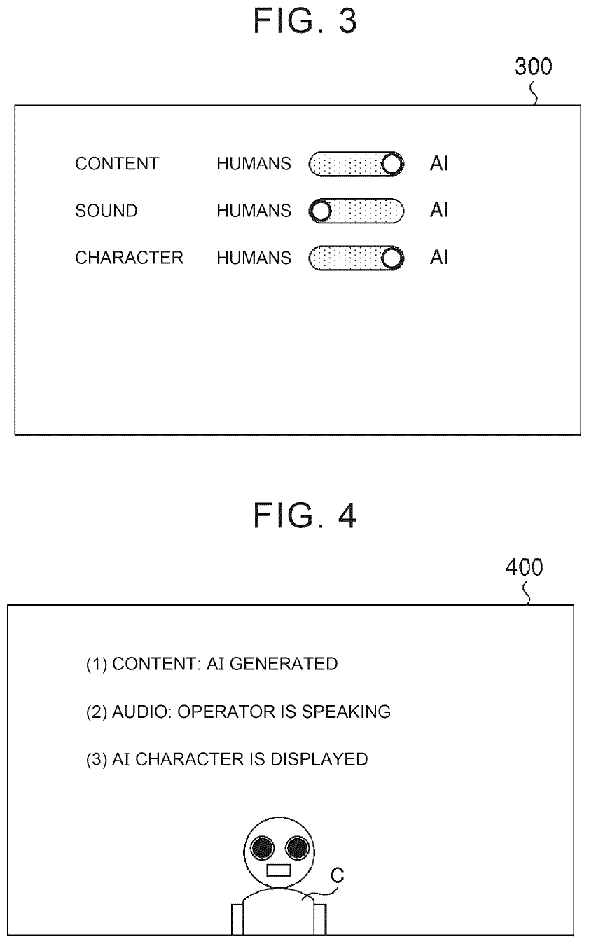

In S102 process, for example, the images 300 illustrated in FIG. 3 may be displayed on a display as the first output unit 105. “Content” in the image 300 means “a person in charge of answer content to a request of the user U”. “Audio” in the image 300 means “a person in charge of audio when responding to a request from the user U”. The “character” in the image 300 means “a character displayed when answering a request from the user U”. Whether “human (e.g., operator O)” or “AI” may be switched by a slider button.

In the exemplary embodiment shown in FIG. 3, AI generates the answer content to the request of the user U, the human emits the sound corresponding to the answer content, and the character generated by AI is displayed when the answer is outputted. The user U may switch between “human” and “AI” at any timing by operating the slider button. For example, in S102 process, after the present operation mode is displayed, the user U may switch between “human” and “AI” by operating the slider button prior to S103 process. When the user U switches between “human” and “AI”, the answer setting data may be updated.

Returning to FIG. 2, the user U may voice-input the request of the user U via the input unit 101 of the notification means identification device 100. The input unit 101 may generate voice information as a request information on the request of the user U based on the voice generated by the user U. The input unit 101 may generate text information as request information based on a voice uttered by the user. The transmission unit 103 may transmit the request information and the mode information indicating the operation mode of the agent service based on the answer setting information to the notification content generation device 200. The mode information may be added to the request information. That is, the mode information may constitute a part of the request information.

The notification content generation device 200 that has received the request information and the mode information (or has received the request information to which the mode information is added) determines, based on the mode information, whether or not AI is in the “AI mode” in which the answer content to the request by the user U is generated (S103). In S103 process, when it is determined that AI mode is set (S103: Yes), the received request information is inputted to the answer content generation unit 204. In this case, the received request information may not be input to the output unit 202.

The answer content generation unit 204 generates answer content (e.g., answer sentence) corresponding to the request related to the request information (S104). Next, the notification content generation device 200 determines, based on the mode information, whether or not AI is in the “AI mode” in which the sound corresponding to the answer content is generated (S105). In S105 process, when it is determined that the answer is AI (S105: Yes), the answer content generated by the answer content generation unit 204 is inputted to the answer voice generation unit 205. The answer voice generation unit 205 generates first voice data corresponding to the answer content generated by the answer content generation unit 204 (S106). The answer transmission unit 206 transmits the first voice information as response information to the notification means identification device 100.

In S105 process, when it is determined that the mode is not AI mode (S105: No), the answer content generated by the answer content generation unit 204 is inputted to the output unit 202. The output unit 202 displays the answer content generated by the answer content generation unit 204. Thereafter, the operator O reads out the answer content generated by the answer content generation unit 204 (S107). The voice uttered when the operator O reads the answer content is input to the notification content generation device 200 via the answer input unit 203. As a result, the second voice information including the voice of the operator O who has read the answer content is generated. The answer transmission unit 206 transmits the second voice information as response information to the notification means identification device 100.

In S103 process, when it is determined that AI is not performed (S103: No), the received request-information is inputted to the output unit 202. In this case, the received request information may not be input to the answer content generation unit 204. The output unit 202 displays a request related to the request information. The operator O then S108 the answer to the request. The voice uttered when the operator O utters the answer content is input to the notification content generation device 200 via the answer input unit 203. As a result, third voice information including the voice of the operator O who utters the answer content is generated.

The notification content generation device 200 determines, based on the mode information, whether or not AI is in the “AI mode” in which the sound corresponding to the answer content is generated (S109). In S109 process, when it is determined that the voice is in AI mode (S109: Yes), the third voice information is inputted to the answer voice generation unit 205. The answer voice generation unit 205 performs a voice recognition process on the third voice information, and outputs text information (S110). Next, the answer voice generation unit 205 generates fourth voice information corresponding to the text information outputted as a result of the voice recognition process (S111). The answer transmission unit 206 transmits the fourth voice information as response information to the notification means identification device 100.

In S109 process, when it is determined that the mode is not AI mode (S109: No), the answer transmission unit 206 transmits the third audio information as response information to the notification means identification device 100.

Upon receiving the answer information, the first output unit 105 of the notification means identification device 100 displays a S112 corresponding to the operation mode of the agent service based on the answer setting information stored in the storage unit 102. In parallel with S112 process, the second output unit 106 outputs the first voice information, the second voice information, the third voice information, or the voice related to the fourth voice information as the answer information (S113).

In S112 process, for example, the images 400 illustrated in FIG. 4 may be displayed on a display as the first output unit 105. The image 400 illustrated in FIG. 4 may be displayed when the operation mode of the agent service is set to the state illustrated in FIG. 3. As illustrated in FIG. 4, the image 400 describes that the answer content is generated by AI, that the sound corresponding to the answer content is the voice of the operator O, and that the character C included in the image 400 is generated by AI. When “human” is selected for the item “character” of the image 300 illustrated in FIG. 3, the image corresponding to the image 400 may include an image related to the operator O instead of the character C.

### Technical Effect

In the system 1, when an answer from the center 20 to a request of the user U of the vehicle 10 is notified to the user U, an image (i.e., visual information) such as the image 400 is displayed. Therefore, according to the system 1, the user U can identify whether or not AI is involved in the response to the requirement of the user U.

### Modified Examples

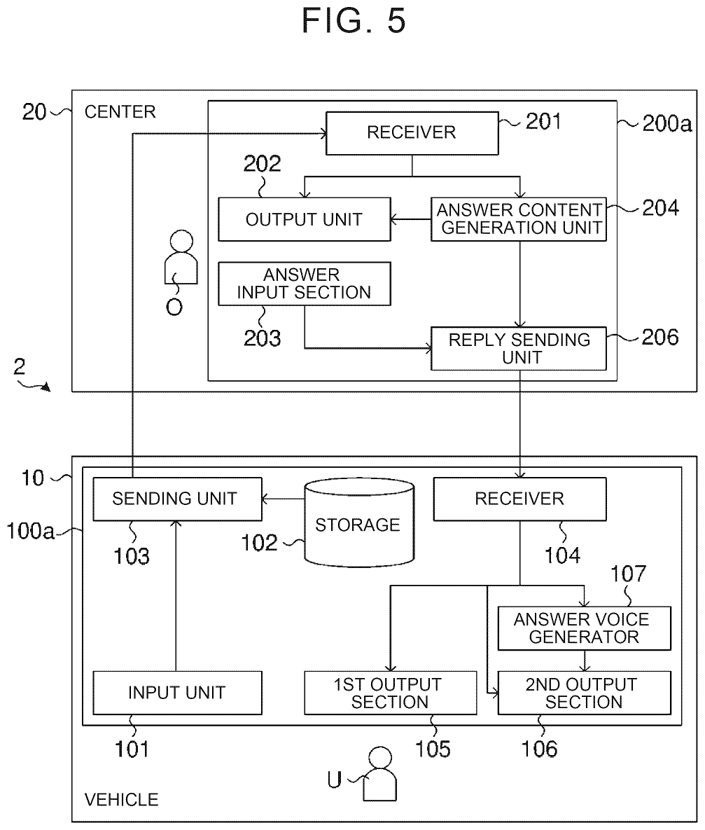

A modification of the above-described embodiment will be described with reference to FIG. 5. In FIG. 5, a system 2 according to a modification includes a notification means identification device 10a mounted on the vehicle 10 and a notification content generating device 20a installed in the center 20. In the system 1 illustrated in FIG. 1, the notification content generation device 200 of the center 20 includes an answer voice generation unit 205. On the other hand, in the system 2 according to the modification, the notification means identification device 100a of the vehicle 10 includes the answer voice generation unit 107.

The operation of the system 2 will be described with reference to the flowchart of FIG. 2. However, the description of the operation of the system 2 that is the same as the operation of the system 1 described above will be omitted as appropriate.

In S105 process, when it is determined that the answer is in AI mode (S105: Yes), the answer transmission unit 206 transmits the answer content generated by the answer content generation unit 204 to the notification means identification device 100a. The notification means identification device 100a inputs the received answer content to the answer voice generation unit 107. The answer voice generation unit 107 generates fifth voice data corresponding to the received answer content (S106). The second output unit 106 outputs a voice related to the fifth voice data (S113).

In S109 process, when it is determined that the mode is AI mode (S109: Yes), the answer transmission unit 206 transmits the third audio information to the notification means identification device 100a. The notification means identification device 100a inputs the received third voice data to the answer voice generation unit 107. The answer voice generation unit 107 performs a voice recognition process on the received third voice information, and outputs text information (S110). Next, the answer voice generation unit 107 generates sixth voice information corresponding to the text information outputted as a result of the voice recognition process (S111). The second output unit 106 outputs the audio related to the sixth audio data (S113).

### Other

In the above-described systems 1 and 2, the voice response to the request of the user U is obtained, but the vehicle 10 may be remotely operated in response to the request of the user U. The remote control of the vehicles 10 may include remote control performed by an operator (i.e., a human) and remote control performed by a AI. When the vehicle 10 is remotely operated, images indicating that the operator is remotely operated or that AI is remotely operated may be displayed. With this configuration, the user U can identify whether or not AI is involved in the remote control.

Various aspects of the disclosure derived from the embodiments and modifications described above are described below.

A system according to an aspect of the present disclosure includes: a first generator capable of generating answer content to a request from a user of a vehicle; and a second generator capable of generating a voice including answer content to the request. The system further includes a display configured to display visual information indicating that at least one of the first generator and the second generator is involved in the voice response when at least one of the first generator and the second generator performs at least one of generation of the answer content to the request and generation of the voice including the answer content to the request.

In the above-described embodiment, the “answer content generation unit 204” corresponds to an example of the “first generator”, the “answer voice generation unit 205” and the “answer voice generation unit 107” correspond to an example of the “second generator”, and the “first output unit 105” corresponds to an example of the “display”.

The system may include a vehicle-side device mounted on the vehicle and a center-side device installed in the center, the vehicle-side device may include the display, and the center-side device may include the first generator and the second generator.

Alternatively, the system may include a vehicle-side device mounted on the vehicle and a center-side device installed in the center, and the vehicle-side device may include the second generator and the display, and the center-side device may include the first generator.

In the system, the visual information may include information indicating whether the first generator has generated the answer content to the request. Alternatively, the system may include information indicating whether or not the second generator has generated a voice including a response to the request. Alternatively, at least one of the above information may be included.

In the system, at least one of information indicating whether to use the first generator and information indicating whether to use the second generator may be added to the request. In the above-described embodiment, the “mode information” corresponds to an example of “information indicating whether or not to use the first generator” and “information indicating whether or not to use the second generator”.

The present disclosure is not limited to the above-described embodiments, and can be modified as appropriate within the scope and spirit of the disclosure that can be read from the claims and the specification as a whole, and a system with such a modification is also included in the technical scope of the present disclosure.

What is claimed is:

1. A system comprising:
a first generator for generating an answer content to a request of a user of a vehicle;
a second generator for generating a voice including the answer content to the request; and
a display for displaying visual information indicating that at least one of the first generator and the second generator is involved in an answer using the voice when at least one of the first generator and the second generator performs at least one of generation of the answer content to the request and generation of the voice including the answer content to the request.

2. The system according to claim 1, further comprising:
a vehicle-side device mounted on the vehicle; and
a center-side device installed in a center, wherein
the vehicle-side device includes the display, and
the center-side device includes the first generator and the second generator.

3. The system according to claim 1, further comprising:
a vehicle-side device mounted on the vehicle; and
a center-side device installed in a center, wherein
the vehicle-side device includes the second generator and the display, and
the center-side device includes the first generator.

4. The system according to claim 1, wherein the visual information includes at least one of information indicating whether the first generator has generated the answer content to the request and information indicating whether the second generator has generated the voice including the answer content to the request.

5. The system according to claim 1, wherein at least one of information indicating whether to use the first generator and information indicating whether to use the second generator is added to the request.
